(19) United States
(12) Patent Application Publication
(10) Pub. No.: US 2024/0131612 A1
(43) Pub. Date: Apr. 25, 2024

(54) SPECIAL TOOLING AND METHOD FOR ELECTRON BEAM WELDING OF CAVITY BODY AND BEAM TUBE OF SUPERCONDUCTING NIOBIUM CAVITY

(71) Applicant: Huainan New Energy Research Center, Huainan, Anhui (CN)

(72) Inventors: Jianguo Ma, Hefei, Anhui (CN); Wei Wen, Huainan, Anhui (CN); Zhihong Liu, Hefei, Anhui (CN); Jia Tao, Huainan, Anhui (CN); Zhenfei Liu, Hefei, Anhui (CN); Liming Peng, Huainan, Anhui (CN); Nian Liu, Huainan, Anhui (CN); Jiefeng Wu, Hefei, Anhui (CN)

(21) Appl. No.: 18/381,648

(22) Filed: Oct. 18, 2023

(30) Foreign Application Priority Data
Oct. 18, 2022 (CN) 202211280799.5

(51) Int. Cl. B23K 15/00; B23K 15/06; B23K 37/047; B23K 37/053

(52) U.S. Cl. CPC B23K 15/0053; B23K 15/002; B23K 15/06; B23K 37/047; B23K 37/0536

(57) ABSTRACT

Disclosed are a special tooling and method for electron beam welding of a cavity body and a beam tube of a superconducting niobium cavity. The special tooling includes a first clamping device for fixing a flange and a second clamping device for fixing a semi-cavity body, wherein the first clamping device and the second clamping device are fixedly connected. A pressing ring of the first clamping device is disposed around a beam tube of a superconducting niobium cavity and cooperates with a base plate to clamp and fix the flange. The second clamping device includes clamping arms evenly distributed along a circumference of the semi-cavity body, and each clamping arm includes a second pressing plate axially disposed along the beam tube and a pressing block that is disposed on an end portion of the second pressing plate and fixes an edge of the semi-cavity body.

### CROSS REFERENCE TO RELATED APPLICATIONS

The present application claims the benefit of Chinese Patent Application No. 202211280799.5 filed on Oct. 19, 2022, the contents of which are incorporated herein by reference in their entirety.

### TECHNICAL FIELD

The present disclosure relates to the manufacturing field of a superconducting niobium cavity in a high-energy accelerator, and specifically, to a special tooling and method for electron beam welding of a cavity body and a beam tube of a superconducting niobium cavity.

### BACKGROUND

A superconducting niobium cavity, as a core component of an accelerator, is widely used in large-scale scientific facilities such as a heavy ion accelerator, a spallation neutron source, and a synchrotron radiation light source. As shown in FIG. 1, the entire cavity is formed by electron beam welding of cavity bodies 1, beam tubes 2, and flanges 3 on both sides. The cavity body 1 is composed of a single cavity or a plurality of cavities. The beam tube 2 and the flange 3 are welded together and are further welded with the cavity body 1 at a joint 4.

A deformation of the welding of the beam tube 2 and the flange 3 may change a ratio of an electric field peak intensity to an acceleration gradient on an inner surface, thereby increasing a loss of the cavity body and affecting a frequency of the cavity body to a certain extent. During controlling of the welding deformation in this region in the past, as components of the designed tooling are mainly connected through welding, the machining accuracy of the tooling will be affected by the welding deformation, such that a relevant component may not fit with and press tightly against a to-be-welded workpiece. Moreover, it is inconvenient to disassemble and assemble this type of tooling, and a surface of the cavity body may be scratched by the components in a disassembling process.

In addition, a poor welding process may result in defects such as backside subsiding and misalignment in a welding process, which may change an inner profile of the entire cavity, affect a distribution of internal electric and magnetic fields, and ultimately affect use performance of the entire cavity. Therefore, a reasonably designed welding tooling and welding technology are crucial to excellent acceleration performance of the superconducting niobium cavity.

### SUMMARY

In order to solve a problem that, after a cavity body and a beam tube are welded, use performance of an existing tooling is affected due to insufficient accuracy and the like in a manufacturing process, the present disclosure provides a special tooling and method for electron beam welding of a cavity body and a beam tube of a superconducting niobium cavity. The special tooling and the welding method in the present disclosure can prevent an inner surface of a semi-cavity body from contacting any component of the tooling during welding of the semi-cavity body and a beam tube, thereby reducing a possibility of scratching the inner surface, meeting a finish requirement of the inner surface of the cavity, and also preventing misalignment in a certain extent.

The technical solutions adopted by the present disclosure to solve the above technical problems are as follows. A special tooling for electron beam welding of a cavity body and a beam tube of a superconducting niobium cavity includes a first clamping device for fixing a flange and a second clamping device for fixing a semi-cavity body, where the first clamping device and the second clamping device are fixedly connected through a connecting component, the first clamping device includes a pressing ring and a base plate with a clamping shaft on one side, and the pressing ring is disposed around the beam tube of the superconducting niobium cavity and cooperates with the base plate to clamp and fix the flange;

the second clamping device includes a plurality of clamping arms evenly distributed along a circumference of the semi-cavity body, each of the plurality of clamping arms includes a second pressing plate axially disposed along the beam tube and a pressing block that is disposed on an end portion of the second pressing plate and fixes an edge of the semi-cavity body, and the second pressing plate is provided with a second groove-shaped hole; and

the connecting component includes a plurality of connecting units one-to-one corresponding to the plurality of clamping arms, and each of the plurality of connecting units includes a first pressing plate and a support plate, where one end of the first pressing plate is connected to the base plate, and the other end is provided with a first groove-shaped hole, the first groove-shaped hole corresponds to a second groove-shaped hole of a second pressing plate in a clamping arm corresponding to the connecting unit, and a total length of the first pressing plate and the second pressing plate is adjustably fixed by using a connecting bolt, to allow a fixed connection between the edge of the semi-cavity body and the base plate; and one end of the support plate is in contact with an outer sidewall of the semi-cavity body, and the other end is connected to the first pressing plate through cooperation between the groove-shaped hole and the connecting bolt, such that the support plate is fixed against the outer sidewall of the semi-cavity body.

As an optimization solution of the special tooling for electron beam welding of a cavity body and a beam tube, the second pressing plate in each of the plurality of clamping arms may be provided with a second connecting block at an end opposite to the pressing block, and the first pressing plate in a connecting unit corresponding to the clamping arm is provided with a first connecting block on a side proximal to the base plate, the second connecting block in the clamping arm and the first connecting block in the connecting unit corresponding to the clamping arm are connected through a screw, and the screw and the support plate are respectively located on two sides of the first pressing plate.

As another optimization solution of the special tooling for electron beam welding of a cavity body and a beam tube, the first pressing plate may be bolted to the base plate through a third connecting block, and a plurality of open slots are provided at an edge of the base plate, where the plurality of open slots one-to-one correspond to the third connecting blocks, and expose a joint between the third connecting block and an end portion of the first pressing plate.

As another optimization solution of the special tooling for electron beam welding of a cavity body and a beam tube, the first pressing plate may be provided with a reinforcing rib on a side facing the beam tube, and one end of the reinforcing rib is bolted to the base plate, and the other end is bolted to an end of the first pressing plate facing the semi-cavity body by using a bolt.

As another optimization solution of the special tooling for electron beam welding of a cavity body and a beam tube, the reinforcing rib may be provided with a third groove-shaped hole that penetrates through the reinforcing rib along a thickness direction of the reinforcing rib, the support plate has a protrusion with a U-shaped groove formed at an end away from the semi-cavity body, fourth groove-shaped holes are symmetrically provided on two sides of the U-shaped groove, the reinforcing rib is located in the U-shaped groove of the protrusion, the third groove-shaped hole corresponds to the fourth groove-shaped hole, such that positions of the connecting bolt in the third groove-shaped hole and the fourth groove-shaped hole are adjustable during fixing of the support plate against the outer sidewall of the semi-cavity body.

As another optimization solution of the special tooling for electron beam welding of a cavity body and a beam tube, the base plate may be of a circular structure with an interstitial hole at a center, a plurality of first positioning pin holes are distributed around the interstitial hole, and the plurality of first positioning pin holes one-to-one correspond to second positioning pin holes on a connecting ring disposed on an end portion of the clamping shaft, to allow fixing and connection of the base plate and the clamping shaft.

A method for electron beam welding of a cavity body and a beam tube of a superconducting niobium cavity by using the above special tooling includes: welding a flange to one end of a beam tube, then performing preprocessing on the flange, the beam tube, and a stamped semi-cavity body, and then clamping the preprocessed flange and semi-cavity body by using the above special tooling, and finally performing electron beam welding after the clamping, where the electron beam welding includes following steps:

1) clamping and fixing a clamping shaft by using a three jaw chuck for the electron beam welding, then rotating the semi-cavity body upwards by 45° from an initial horizontal position parallel to an X axis, correcting axial and radial runouts of a welded seam to level the superconducting niobium cavity while maintaining a position, and after the leveling, tightening a bolt on a first clamping device and placing the device in a vacuum chamber;

2) vacuumizing the vacuum chamber to less than 10 mbar to 5 mbar to enable the three jaw chuck to drive the superconducting niobium cavity to rotate, and performing tack welding at a to-be-welded position on an inner side of the semi-cavity body by using an electron beam current of 2 mA to 5 mA, where the tack welding is performed on four points evenly distributed around the welded seam;

3) using an electron beam current of 15 mA to 20 mA in form of a circular wave, a sine wave, or an 8-shaped scanning wave to complete welding at the to-be-welded position on the inner side of the semi-cavity body at a scanning amplitude of 0.3 mm to 1 mm, then unvacuuming, removing a second clamping device that fixes the semi-cavity body, and re-vacuumizing the vacuum chamber to be less than 10 mbar to 5 mbar to enable the three jaw chuck to drive the superconducting niobium cavity to rotate to the initial horizontal position in the step 1); and

4) using an electron beam current of 35 mA to 45 mA in form of the circular wave, the sine wave, or the 8-shaped scanning wave to complete welding at a to-be-welded position on an outer side of the semi-cavity body at a scanning amplitude of 0.5 mm to 2 mm, to complete a welded connection between the semi-cavity body and the beam tube.

As an optimization solution of the method for electron beam welding of a cavity body and a beam tube, the preprocessing includes: placing the flange and the beam tube which are welded with each other together with the stamped semi-cavity body into a pickling solution to perform pickling; and after the pickling, spraying ultrapure water, and drying in an ultra-clean room to complete the preprocessing, where the pickling solution is an acid solution of a mixture of hydrofluoric acid, nitric acid, and phosphoric acid in a mass ratio of 1:1:2.

As another optimization solution of the method for electron beam welding of a cavity body and a beam tube, the clamping the preprocessed flange and semi-cavity body by using the special tooling specifically may include:

i) clamping the flange by using the first clamping device, including:

installing a pressing ring on a side of the flange facing the beam tube, installing a base plate on another side of the flange, and then fixing the clamping shaft and the base plate, where

all bolts and nuts used for installation and fixing are not fully tightened to facilitate subsequent leveling;

ii) connecting a connecting component with the first clamping device, including:

assembling a first pressing plate and a support plate of each connecting unit in the connecting component, and then bolting the first pressing plate of each connecting unit to the base plate; and

iii) connecting a second clamping device to the connecting component and the semi-cavity body, including:

aligning joints of the semi-cavity body and the beam tube, then assembling a second pressing plate with a pressing block of the second clamping device to form a plurality of clamping arms, then assembling the second pressing plate on each of the plurality of clamping arms with a first pressing plate of one connecting unit, and adjusting a total length of the second pressing plate and the first pressing plate to make the pressing block press against an equatorial edge of the semi-cavity body, and then using a bolt to make a fixed connection, to complete the clamping operation.

As another optimization solution of the method for electron beam welding of a cavity body and a beam tube, in a step of welding on the inner side of the step 3) and a step of welding on an outer side of the step 4), an acceleration voltage is 40 kV to 70 kV, a speed of a welding line is 6 mm/s to 10 mm/s, and a scanning frequency of an electron beam is 40 Hz to 500 Hz.

Compared with the prior art, the present disclosure has following beneficial effects.

1) The special tooling in the present disclosure fixes the flange through cooperation between the base plate and the pressing ring of the first clamping device. It adjustably fixes the total length of the first pressing plate of the connecting component and the second pressing plate of the second clamping device by using the bolt, so as to fix the equatorial edge of the semi-cavity body by using the pressing block at a front end of the second pressing plate. Meanwhile, it fixes the support plate against the outer side of the semi-cavity body, to make a clamping action more stable. In order to further improve stability of the clamping, one connecting block is disposed on each of the two pressing plates, and the two connecting blocks are connected by using the screw. The screw and the support plate are located on opposite sides of the two pressing plates, thereby further improving the clamping stability and clamping effect. No component of the entire special tooling in the present disclosure is in contact with the inner surface of the semi-cavity body, thereby reducing a possibility of scratching the inner surface and meeting a finish requirement of the inner surface of the cavity.

2) All components of the special tooling in the present disclosure are connected through corporation of the bolts, the screw holes, and the nuts, and important screw holes are designed as groove-shaped holes. This not only avoids an effect on performance of the superconducting niobium cavity due to poor welding accuracy of an existing tooling during the welded connection, but also facilitates convenient assembling and disassembling processes, and greatly improves production efficiency during the welding of the semi-cavity body and the beam tube and improves welded product quality.

3) When the special tooling in the present disclosure is used for the electron beam welding, the horizontally fixed tooling and a to-be-welded workpiece are first rotated upwards by 45 degrees for leveling, and then a small beam current is used to perform the welding on the inner side of the cavity. After that, the tooling and the to-be-welded workpiece are rotated back to the initial horizontal state, and then a large beam current is used to perform the welding on the outer side of the cavity. This welding method can effectively avoid excessive subsiding on a back side of the welded seam, and preventing misalignment in a certain extent.

### BRIEF DESCRIPTION OF THE DRAWINGS

FIG. 1 is a schematic structural view of a superconducting niobium cavity;

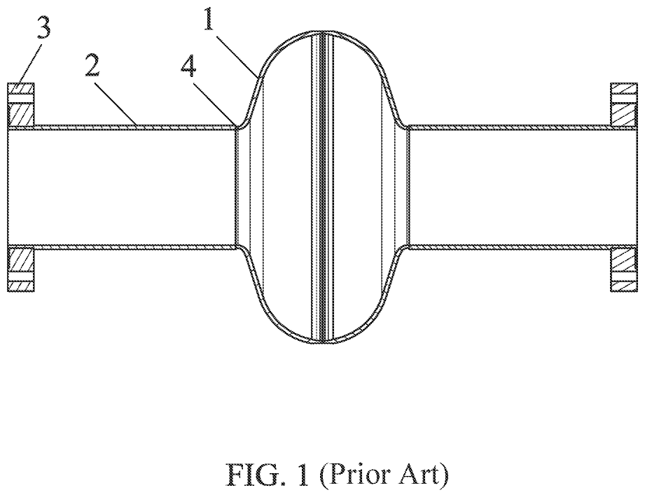

FIG. 2 is a perspective schematic view illustrating a special tooling clamping a semi-cavity body and a beam tube according to the present disclosure;

FIG. 3 is a cross-sectional view illustrating a special tooling clamping a semi-cavity body and a beam tube according to the present disclosure;

FIG. 4 is a schematic structural view of a base plate of a first clamping device;

FIG. 5 is a schematic structural view of a clamping shaft of a first clamping device;

FIG. 6 is a schematic structural view of a pressing ring of a first clamping device;

FIG. 7 is a schematic structural view of a first pressing plate of a connecting component;

FIG. 8 is a schematic structural view of a first connecting block of a connecting component;

FIG. 9 is a schematic structural view of a second connecting block of a second clamping device;

FIG. 10 is a schematic structural view of a third connecting block of a connecting component;

FIG. 11 is a schematic structural view of a second pressing plate of a second clamping device;

FIG. 12 is a schematic structural view of a reinforcing rib of a connecting component;

FIG. 13 is a schematic structural view of a support plate of a connecting component;

FIG. 14 is a schematic structural view of a pressing block of a second clamping device;

FIG. 15 is a schematic view illustrating a state of inner-side welding of a semi-cavity body; and

FIG. 16 is a schematic view illustrating a state of outer-side welding of a semi-cavity body.

Reference numerals: 1. semi-cavity body; 2. beam tube; 3. flange; 4. joint; 5. first clamping device; 501. base plate; 502. clamping shaft; 503. pressing ring; 504. open slot; 505. interstitial hole; 506. first positioning pin hole; 507. connecting ring; 508. second positioning pin hole; 6. second clamping device; 601. second pressing plate; 602. pressing block; 603. second groove-shaped hole; 604. second connecting block; 7. connecting component; 701. first pressing plate; 702. support plate; 703. first groove-shaped hole; 704. first connecting block; 705. screw; 706. third connecting block; 707. reinforcing rib; 708. third groove-shaped hole; 709. fourth groove-shaped hole.

### DETAILED DESCRIPTION

The technical solutions of the present disclosure are further described in detail below with reference to specific embodiments. The following embodiments of the present disclosure omit descriptions, such as fixing connection between a four-jaw chuck and a clamping shaft, rotation of the four-jaw chuck, correction after a to-be-welded workpiece is clamped and mounted by using the special tooling of the present disclosure, and structures of a vacuum chamber, an electron beam welding gun, and related equipment, which are known or should be known to those skilled in the art and should be understood as the prior art. It should be understood that the terms “first”, “second”, and the like do not indicate any order or importance, but are used to distinguish between various components.

### Embodiment 1

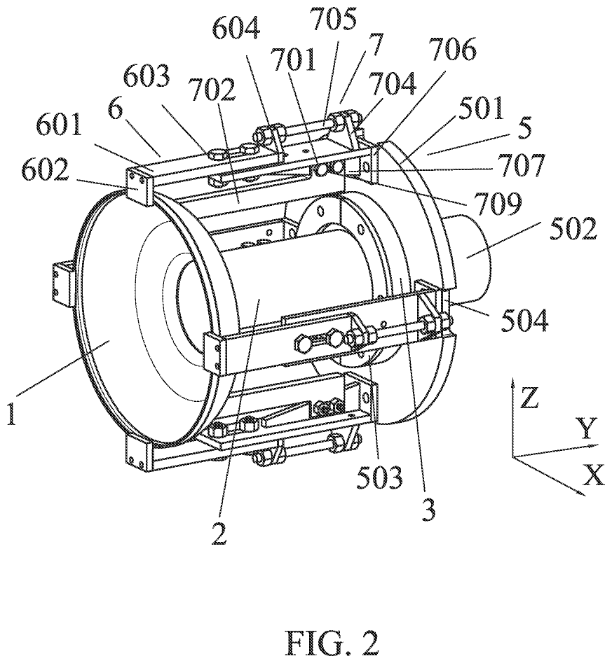

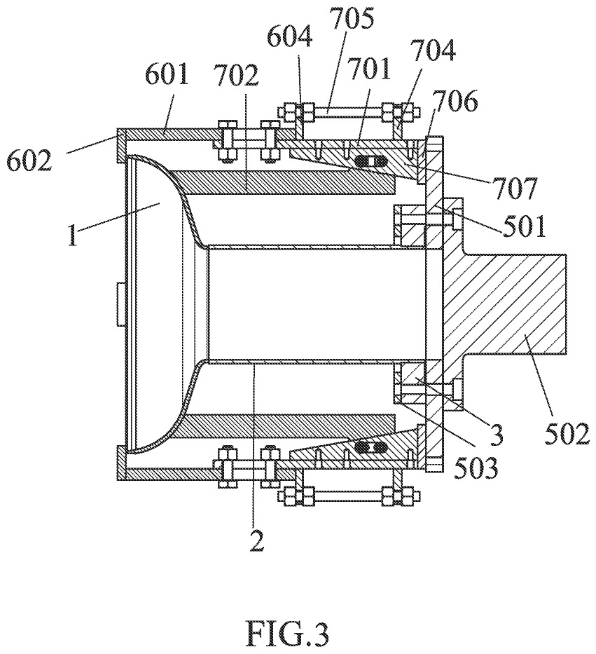

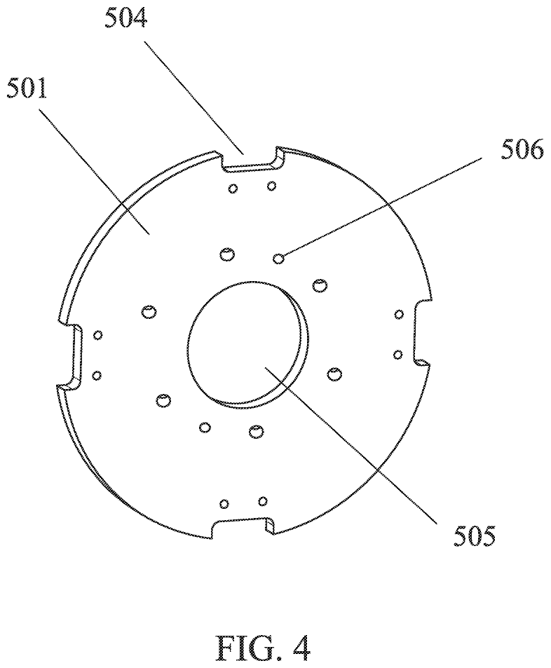

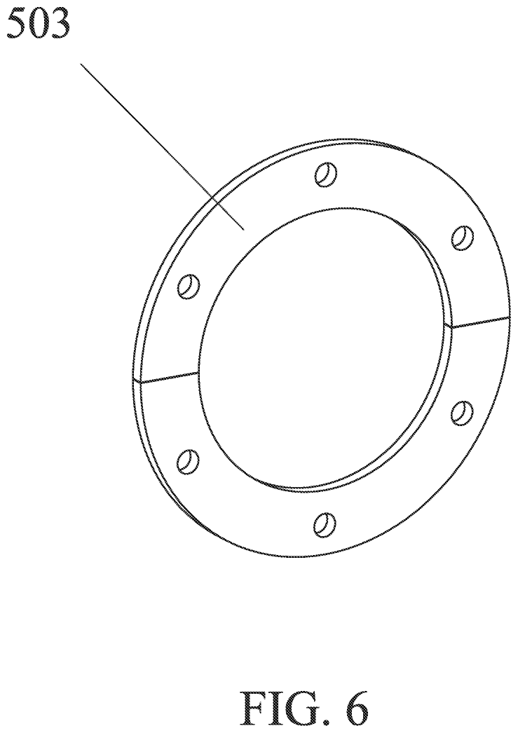

As shown in FIG. 2 and FIG. 3, a special tooling for electron beam welding of a cavity body and a beam tube of a superconducting niobium cavity includes a first clamping device 5 for fixing a flange 3 and a second clamping device 6 for fixing a semi-cavity body 1. The first clamping device 5 and the second clamping device 6 are fixedly connected through a connecting component 7. The first clamping device 5 includes a pressing ring 503 and a base plate 501 with a clamping shaft 502 on one side. As shown in FIG. 4, the base plate 501 is a circular plate with a diameter greater than a diameter of the flange 3. The clamping shaft 502 is configured to connect a four-jaw chuck during subsequent welding. As shown in FIG. 6, the pressing ring 503 is of a structure with two symmetrical semicircle rings. Generally, an inner diameter of the pressing ring 503 is slightly larger than an outer diameter of a beam tube 2. In this way, when the pressing ring 503 is disposed around the beam tube 2 of the superconducting niobium cavity and cooperates with the base plate 501 to clamp and fix the flange 3, the inner diameter of the pressing ring 503 does not come into contact with the outer diameter of the beam tube 2. An outer edge of the pressing ring 503 is generally flush with an edge of the flange 3. The pressing ring 503, the flange 3, and the base plate 501 each are provided with a corresponding bolt hole, and are connected and fixed by inserting a connecting bolt and a nut into the bolt hole.

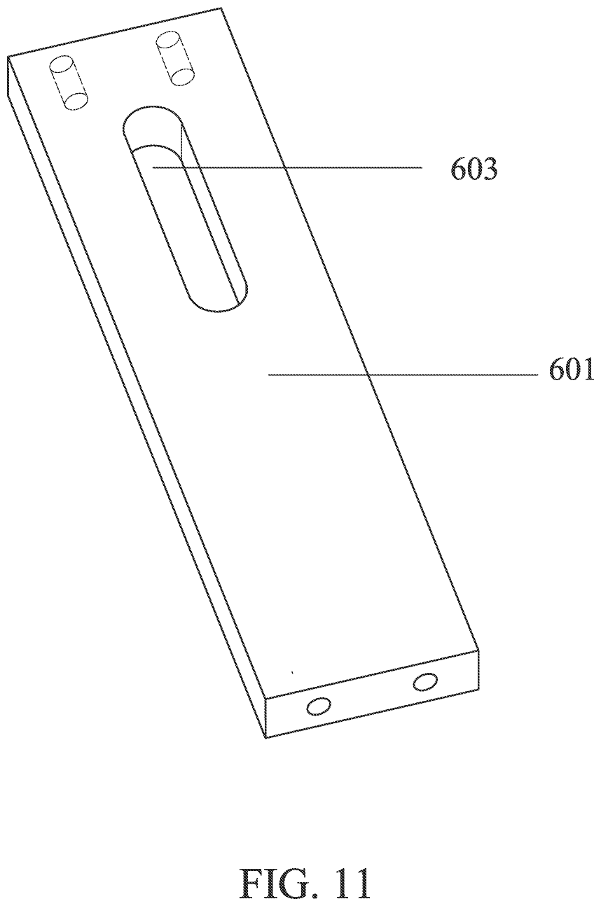

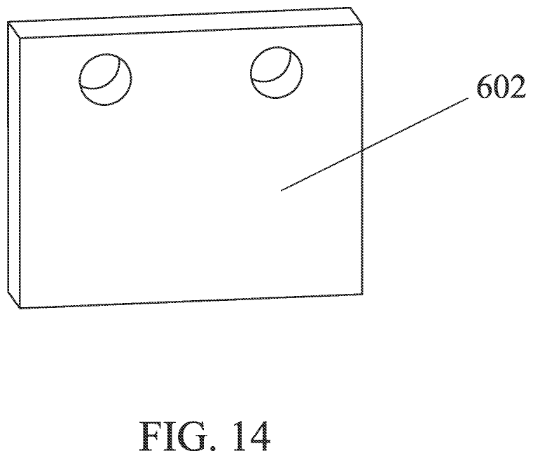

The second clamping device 6 includes a plurality of clamping arms evenly distributed around a circumference of the semi-cavity body 1. There are four clamping arms shown in FIG. 2, which are evenly distributed around the circumference of the semi-cavity body 1. It is also conceivable that three or five clamping alarms may be provided. Each of the clamping arms includes a second pressing plate 601 axially disposed along the beam tube 2 and a pressing block 602 that is disposed on an end portion of the second pressing plate 601 and fixes an edge of the semi-cavity body 1. The second pressing plate 601 is provided with a second groove-shaped hole 603, as shown in FIG. 11. The second pressing plate 601 is provided with two threaded holes at an end, as shown in FIG. 14. The pressing block 602 has two threaded holes, and the two threaded holes of the pressing block 602 correspond to the two threaded holes at the end of the second pressing plate 601, such that the pressing block 602 and the second pressing plate 601 can be fixedly connected by a connecting screw.

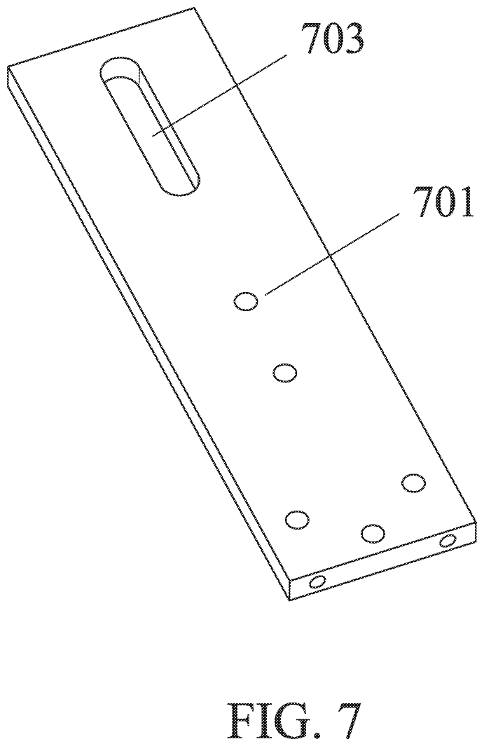

The connecting component 7 includes a plurality of connecting units one-to-one corresponding to the plurality of clamping arms, and each of the plurality of connecting units includes a first pressing plate 701 and a support plate 702. As show in FIG. 7, one end of the first pressing plate 701 is connected to the base plate 501, and the other end is provided with a first groove-shaped hole 703. The first groove-shaped hole 703 corresponds to a second groove-shaped hole 603 of a second pressing plate 601 of respective one of the plurality of clamping arms corresponding to the one of the plurality of connecting units, and a total length of the first pressing plate 701 and the second pressing plate 601 are adjustably fixed by using a connecting bolt, to allow a fixed connection between the edge of the semi-cavity body 1 and the base plate 501. The adjustable fixing of the total length means that the total length of the first pressing plate 701 and the second pressing plate 601 can be adjusted by changing a length of the overlapping region when the two groove-shaped holes are aligned. When the two groove-shaped holes are completely overlapped, the total length of the two pressing plates is minimum. In this case, the connecting bolt can be inserted into the two groove-shaped holes for fixing. When an overlapping portion of the two groove-shaped holes can only accommodate one connecting bolt, the total length is maximum. In this way, the total length is adjusted to enable the pressing block 602 to clamp and fix an equatorial edge of the semi-cavity body 1. One end of the support plate 702 is in contact with an outer sidewall of the semi-cavity body 1, and the other end is connected to the first pressing plate 701 through cooperation between the groove-shaped holes and the connecting bolt, such that the support plate 702 can be fixed against the outer sidewall of the semi-cavity body 1.

In this embodiment, all connections between the components are detachable connections achieved by using bolts and nuts.

In this embodiment, the support plate 702 is fixed against one end of the outer sidewall of the semi-cavity body 1, and it is shaped by numerical control machining to fit a shape of a curved surface of a corresponding clamping position on an outer side of the semi-cavity body 1. For semi-cavity bodies 1 with similar equatorial diameters and different cavity shapes, it only needs to replace the support plate 702 or perform numerical control milling on an end portion of the support plate 702. That is, it improves adaptability of the designed welding tooling to different superconducting cavities with different cavity shapes.

The above is a basic implementation of the present disclosure, which can be further improved, optimized, and limited to obtain following embodiments:

### Embodiment 2

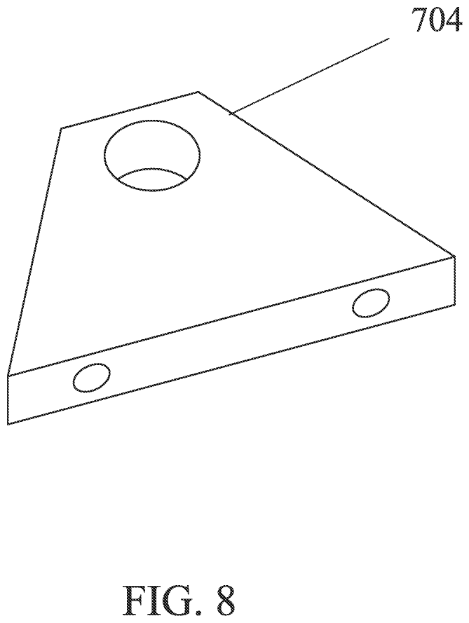

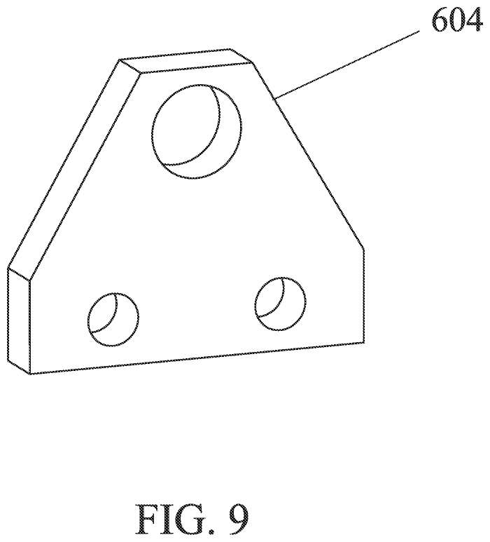

This embodiment, as an improved solution based on Embodiment 1, has a same main structure as Embodiment 1. The improvements are as follows. As shown in FIG. 2 and FIG. 3, the second pressing plate 601 in each of the plurality of clamping arms is provided with a second connecting block 604 at a respective end opposite to the pressing block 602. A structure of the second connecting block 604 is shown in FIG. 9. From FIG. 9, it can be seen that the structure of the second connecting block 604 has a rectangular lower portion and a trapezoidal upper portion. There are two bolt holes in the lower region, and the two bolt holes correspond to bolt holes disposed at an end of the second pressing plate 601 proximal to the second groove-shaped hole 603, according to a structure of the second pressing plate 601 shown in FIG. 11. In this way, the second connecting block 604 can be fixed on a surface of the end portion of the second pressing plate 601 by using a connecting screw. There is an unthreaded hole for installing a screw 705 in the upper region of the second connecting block 604. In a connection unit corresponding to the clamping arm, a first connecting block 704 is disposed on a side of the first pressing plate 701 proximal to the base plate 501. A structure of the first connecting block 704 is shown in FIG. 8. From FIG. 8, it can be seen that the first connecting block 704 is of a trapezoidal structure. There is one unthreaded hole for installing the screw 705 on the first connecting block 704, and two screw holes are formed on the long side. These two screw holes correspond to two of the three screw holes formed at an end of the first pressing plate 701 away from the first groove-shaped hole 703 on in the structure of the first pressing plate 701 as shown in FIG. 7. In such a case, the first connecting block 704 can be fixed on a surface of the first pressing plate 701 by using a connecting screw. Two connecting holes formed on an end portion of the first pressing plate 701 correspond to screw holes formed on the base plate 501 and a connecting screw can be used for connection. The second connecting block 604 in each one of the plurality of clamping arms and the first connecting block 704 in respective one of the plurality of connecting units corresponding to the one of the plurality of clamping arms are connected through the screw 705, and the screw 705 and the support plate 702 are respectively located on two sides of each first pressing plate 701. The screw 705, which extends through the unthreaded holes on the second connecting block 604 and on the first connecting block 704, can be fixed by using a nut.

### Embodiment 3

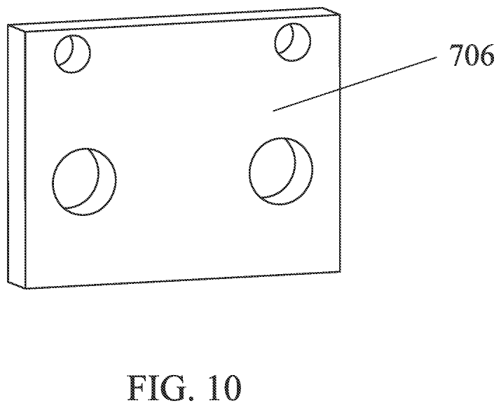

This embodiment, as another improved solution based on Embodiment 1, has a same main structure as Embodiment 1. The improvements are as follows. As shown in FIG. 2 and FIG. 3, the first pressing plate 701 is connected to the base plate 501 by using a bolt through a third connecting block 706. A structure of the third connecting block 706 is shown in FIG. 10, and there are two large holes and two small holes on the third connecting block 706. The two small holes allow a screw to achieve connection with an end portion of the first pressing plate 701, and the two large holes allow a connecting bolt to achieve fixed connection with the base plate 501. A plurality of open slots 504 are provided at an edge of the base plate 501. The plurality of open slots 504 one-to-one correspond to the third connecting blocks 706, and expose a joint between the third connecting block 706 and the end portion of the first pressing plate 701, making it easy to tighten the connecting screw or bolt for fixing.

### Embodiment 4

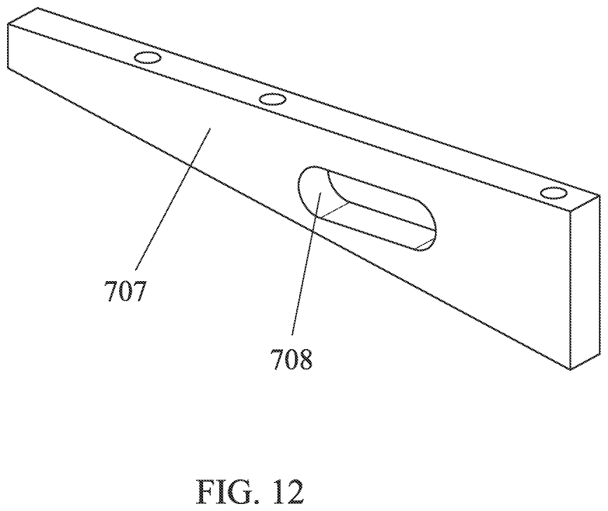

This embodiment, as another improved solution based on Embodiment 1, has a same main structure as Embodiment 1. The improvements are as follows. As shown in FIG. 2 and FIG. 3, the first pressing plate 701 is provided with a reinforcing rib 707 on a side facing the beam tube 2. One end of the reinforcing rib 707 is connected to the base plate 501 by using a bolt, and the other end is connected to an end of the first pressing plate 701 facing the semi-cavity body 1 by using a bolt. In practice, a structure of the reinforcing rib 707 is shown in FIG. 12. The reinforcing rib 707 is a right-angled trapezoid in shape. The longer right-angled edge among two right-angled edges is connected to a bottom surface of the first pressing plate 701 (by using a screw hole on the longer right-angled edge), and the shorter right-angled edge is connected to the base plate 501 by using a bolt.

### Embodiment 5

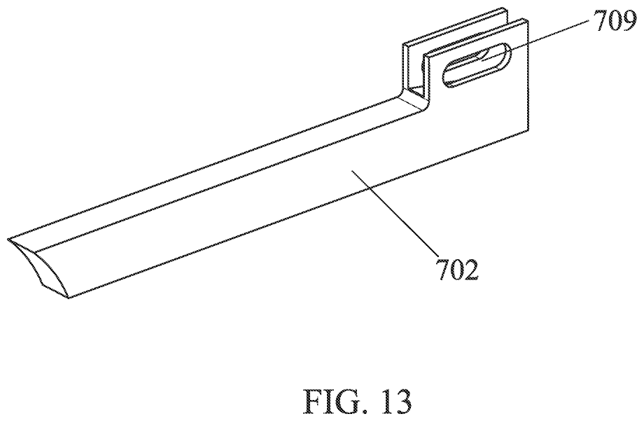

This embodiment, as an improved solution based on Embodiment 4, has a same main structure as Embodiment 4. The improvements are as follows. As shown in FIG. 12, the reinforcing rib 707 is provided with a third groove-shaped hole 708 that penetrates through the reinforcing rib 707 along a thickness direction thereof. As shown in FIG. 13, the support plate 702 has a protrusion with a U-shaped groove at an end away from the semi-cavity body 1, and fourth groove-shaped holes 709 are symmetrically disposed on two sides of the U-shaped groove. The reinforcing rib 707 is located in the U-shaped groove of the protrusion. The third groove-shaped hole 708 corresponds to the fourth groove-shaped hole 709. Positions of the connecting bolt in the third groove-shaped hole 708 and in the fourth groove-shaped hole 709 are adjustable to during fixing of the support plate 702 against the outer sidewall of the semi-cavity body 1.

### Embodiment 6

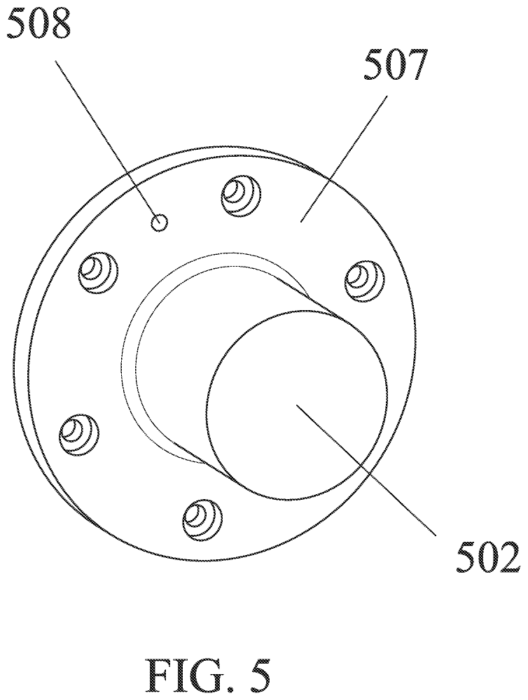

This embodiment, as another improved solution based on Embodiment 1, has a same main structure as Embodiment 1. The improvements are as follows. As shown in FIG. 4, the base plate 501 is of a circular structure with an interstitial hole 505 formed at a center. The device with the interstitial hole 505 has reduced weight and equipment operating load, avoids air entrainment in an assembly gap of a component during vacuumization, and improves efficiency of the vacuumization. A plurality of first positioning pin holes 506 are distributed around the interstitial hole 505, and the plurality of first positioning pin holes 506 one-to-one correspond to second positioning pin holes 508 of the connecting ring 507 disposed on the end portion of the clamping shaft 502, to allow fixing and connection of the base plate 501 and the clamping shaft 502. FIG. 5 is a schematic view of the clamping shaft 502.

### Embodiment 7

This embodiment provides a method for electron beam welding of a cavity body and a beam tube of a superconducting niobium cavity by using the special tooling in Embodiment 1. A beam tube 2 used is a pure niobium beam tube with a wall thickness of 2 mm, and a semi-cavity body 1 is also a pure niobium material with a wall thickness of 2 mm. Specific steps of the method are as follows.

1) Preprocessing of a to-be-Welded Workpiece

Placing the flange 3 and the beam tube 2 which are welded with each other together with the stamped semi-cavity body 1 into a pickling solution to perform pickling for 8 min to 10 min. The pickling solution is an acid solution of a mixture of hydrofluoric acid (40 wt %), nitric acid (70 wt %), and phosphoric acid (80 wt %) in a mass ratio of 1:1:2. After the pickling, spraying ultrapure water, and getting dried in an ultra-clean room to complete the preprocessing.

2) Clamping the Preprocessed Flange 3 and Semi-Cavity Body 1 which are Preprocessed by Using the Special Tooling

i) Clamping the Flange 3 by Using a First Clamping Device 5

Installing a pressing ring 503 on a side of the flange 3 facing the beam tube 2, installing a base plate 501 on another side of the flange 3, and then fixing a clamping shaft 502 with the base plate 501.

In the step, all bolts and nuts used for installation and fixing are not fully tightened, to facilitate subsequent leveling.

ii) Connecting a Connecting Component 7 with the First Clamping Device 5

Assembling a first pressing plate 701 and a support plate 702 of each connecting unit of the connecting component 7, and then bolting the first pressing plate 701 of each connecting unit to the base plate 501.

iii) Connecting a Second Clamping Device 6 to the Connecting Component 7 and the Semi-Cavity Body 1

Aligning joints of the semi-cavity body 1 and the beam tube 2, then assembling a second pressing plate 601 with a pressing block 602 of the second clamping device 6 to form a plurality of clamping arms, then assembling the second pressing plate 601 on each of the plurality of clamping arms with a first pressing plate 701 of one connecting unit, and adjusting a total length of the second pressing plate 601 and the first pressing plate 701 to make the pressing block 602 press against an equatorial edge of the semi-cavity body 1, and then using a bolt to make a fixed connection, to complete the clamping operation.

3) Correction

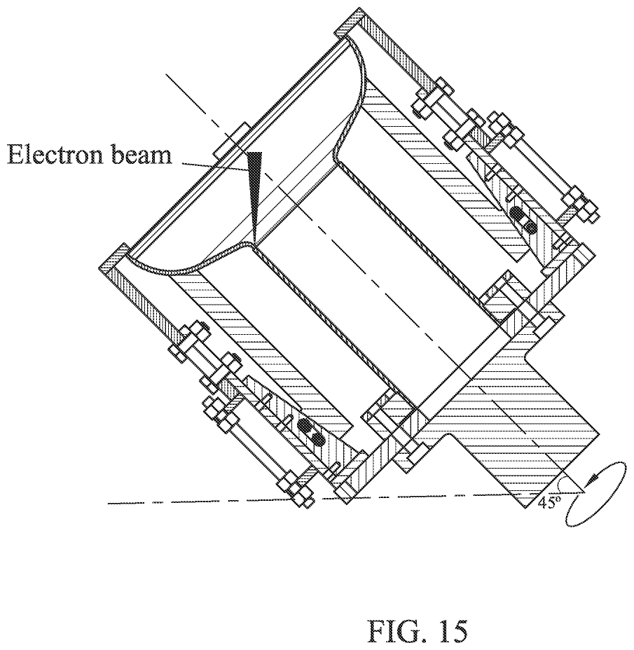

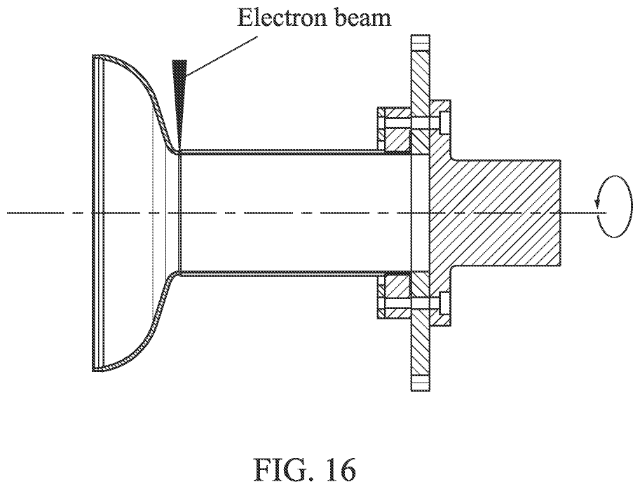

Clamping and fixing the clamping shaft 502 by using a three-jaw chuck for the electron beam welding, rotating the semi-cavity body 1 upwards by 45° from an initial horizontal position parallel to an X axis. As shown in FIG. 15 and FIG. 16, correcting, at a maintained position, axial and radial runouts of a welded seam to level the superconducting niobium cavity, and after the leveling, tightening a bolt on the first clamping device 5, and placing the device in a vacuum chamber.

4) Tack Welding

Vacuuming the vacuum chamber to less than 10 mbar to 5 mbar to enable the three-jaw chuck to drive the superconducting niobium cavity to rotate, and performing tack welding at a to-be-welded position on an inner side of the semi-cavity body 1 by using an electron beam current of 2 mA. Herein, the tack welding is performed at four points evenly distributed around the welded seam.

5) Inner-Side Welding

welding at the to-be-welded position on the inner side of the semi-cavity body 1 by an electron beam current of 15 mA in form of a circular wave at a scanning amplitude of 0.3 mm.

In the step, an acceleration voltage is 40 kV, a speed of a welding line is 6 mm/s, and a scanning frequency of an electron beam is 40 Hz.

6) Tooling Resetting

Unvacuuming the vacuum chamber, removing the second clamping device 6 that fixes the semi-cavity body 1, and re-vacuuming the vacuum chamber to less than 10 mbar to 5 mbar to enable the three-jaw chuck to drive the superconducting niobium cavity to rotate to the initial horizontal position in the step 1).

7) Outer-Side Welding

welding at a to-be-welded position on an outer side of the semi-cavity body 1 by an electron beam current of 35 mA in form of the circular wave at a scanning amplitude of 0.5 mm, to complete a welded connection between the semi-cavity body 1 and the beam tube 2.

In the step, the acceleration voltage is 40 kV, the speed of the welding line is 6 mm/s, and the scanning frequency of the electron beam is 40 Hz.

After the welding, cooling in the vacuum chamber for 30 min, and then taking out the workpiece from the vacuum chamber. After measurement, an amount of subsiding on a back side of the welded seam is 0.09 mm, and a misalignment capacity is 0.03 mm, which meet the requirement of design accuracy.

### Embodiment 8

This embodiment has same steps as Embodiment 7, except for fine tuning of parameters. The step of fine tuning includes following steps.

4) Tack Welding

Vacuuming the vacuum chamber to less than 10 mbar to 5 mbar to enable the three-jaw chuck to drive the superconducting niobium cavity to rotate, and performing tack welding at a to-be-welded position on an inner side of the semi-cavity body 1 by using an electron beam current of 3.5 mA. The tack welding is performed at four points evenly distributed around the welded seam.

5) Inner-Side Welding

welding at the to-be-welded position on the inner side of the semi-cavity body 1 by using an electron beam current of 18 mA in the form of a sine wave at a scanning amplitude of 0.6 mm.

In the step, an acceleration voltage is 55 kV, a speed of a welding line is 8 mm/s, and a scanning frequency of an electron beam is 300 Hz.

7) Outer-Side Welding

welding at a to-be-welded position on an outer side of the semi-cavity body 1 by using an electron beam current of 40 mA in the form of the sine wave at a scanning amplitude of 1.2 mm, to complete a welded connection between the semi-cavity body 1 and the beam tube 2.

In the step, the acceleration voltage is 55 kV, the speed of the welding line is 8 mm/s, and the scanning frequency of the electron beam is 300 Hz.

After the welding, cooling in the vacuum chamber for 30 min, and then taking out the workpiece from the vacuum chamber. After measurement, an amount of subsiding on a back side of the welded seam is 0.09 mm, and a misalignment capacity is 0.02 mm, which meet the requirement of a design accuracy.

### Embodiment 9

This embodiment has same steps as Embodiment 7, except for fine tuning of parameters. The step of fine tuning lies includes following steps.

4) Tack Welding

Vacuuming the vacuum chamber to less than 10 mbar to 5 mbar to enable the three-jaw chuck to drive the superconducting niobium cavity to rotate, and performing tack welding at a to-be-welded position on an inner side of the semi-cavity body 1 by using an electron beam current of 5 mA. The tack welding is performed at four points evenly distributed around the welded seam.

5) Inner-Side Welding

welding at the to-be-welded position on the inner side of the semi-cavity body 1 by using an electron beam current of 20 mA in form of an 8-shaped scanning wave at a scanning amplitude of 1 mm.

In the step, an acceleration voltage is 70 kV, a speed of a welding line is 10 mm/s, and a scanning frequency of an electron beam is 500 Hz.

7) Outer-Side Welding

welding at a to-be-welded position on an outer side of the semi-cavity body 1 by using an electron beam current of 45 mA in form of the 8-shaped scanning wave at a scanning amplitude of 2 mm, to complete a welded connection between the semi-cavity body 1 and the beam tube 2.

In the step, the acceleration voltage is 70 kV, the speed of the welding line is 10 mm/s, and the scanning frequency of the electron beam is 500 Hz.

After the welding, cooling in the vacuum chamber for 30 min, and then taking out the workpiece from the vacuum chamber. After measurement, an amount of subsiding on a back side of the welded seam is 0.07 mm, and a misalignment capacity is 0.02 mm, which meet the requirement of design accuracy.

1. A special tooling for electron beam welding of a cavity body and a beam tube of a superconducting niobium cavity, comprising a first clamping device for fixing a flange and a second clamping device for fixing a semi-cavity body, wherein the first clamping device and the second clamping device are fixedly connected through a connecting component, wherein the first clamping device comprises a pressing ring and a base plate with a clamping shaft disposed on one side, and the pressing ring is disposed around the beam tube of the superconducting niobium cavity and cooperates with the base plate to clamp and fix the flange;
the second clamping device comprises a plurality of clamping arms evenly distributed along a circumference of the semi-cavity body, each of the plurality of clamping arms comprises a second pressing plate axially disposed along the beam tube and a pressing block that is disposed on an end portion of each second pressing plate and fixes an edge of the semi-cavity body, and each second pressing plate is provided with a second groove-shaped hole; and
the connecting component comprises a plurality of connecting units one-to-one corresponding to the plurality of clamping arms, and each one of the plurality of connecting units comprises a first pressing plate and a support plate, wherein one end of each first pressing plate is connected to the base plate, and the other end is provided with a first groove-shaped hole, the first groove-shaped hole corresponds to a second groove-shaped hole of each second pressing plate of respective one of the plurality of clamping arms corresponding to the one of the plurality of connecting units, and a total length of each first pressing plate and each second pressing plate is adjustably fixed by using a connecting bolt, to allow a fixed connection between the edge of the semi-cavity body and the base plate; and one end of the support plate is in contact with an outer sidewall of the semi-cavity body, and the other end is connected to individual first pressing plate through cooperation between the groove-shaped holes and the connecting bolt, such that the support plate is fixed against the outer sidewall of the semi-cavity body.

2. The special tooling for electron beam welding of a cavity body and a beam tube of a superconducting niobium cavity according to claim 1, wherein each second pressing plate in the plurality of clamping arms is provided with a second connecting block at an end opposite to the pressing block, and each first pressing plate in a connecting unit corresponding to the clamping arm is provided with a first connecting block on a side proximal to the base plate, the second connecting block in each one of the plurality of clamping arms and the first connecting block in respective one of the plurality of connecting units corresponding to the one of the plurality of clamping arms are connected through a screw, and the screw and the support plate are respectively located on two sides of each first pressing plate.

3. The special tooling for electron beam welding of a cavity body and a beam tube of a superconducting niobium cavity according to claim 1, wherein each first pressing plate is bolted to the base plate through a third connecting block, and a plurality of open slots are provided at an edge of the base plate, wherein the plurality of open slots one-to-one correspond to the third connecting blocks, and expose a joint between each third connecting block and an end portion of each first pressing plate.

4. The special tooling for electron beam welding of a cavity body and a beam tube of a superconducting niobium cavity according to claim 1, wherein each first pressing plate is provided with a reinforcing rib on a side facing the beam tube, and one end of each reinforcing rib is bolted to the base plate, and the other end is bolted to an end of respective first pressing plate facing the semi-cavity body by using a bolt.

5. The special tooling for electron beam welding of a cavity body and a beam tube of a superconducting niobium cavity according to claim 4, wherein each reinforcing rib is provided with a third groove-shaped hole that penetrates through the reinforcing rib along a thickness direction of the reinforcing rib, the support plate has a protrusion with a U-shaped groove formed at an end away from the semi-cavity body, fourth groove-shaped holes are symmetrically provided on two sides of the U-shaped groove, the reinforcing rib is located in the U-shaped groove of the protrusion, the third groove-shaped hole corresponds to the fourth groove-shaped hole, such that positions of the connecting bolt in the third groove-shaped hole and the fourth groove-shaped hole are adjustable during fixing of the support plate against the outer sidewall of the semi-cavity body.

6. The special tooling for electron beam welding of a cavity body and a beam tube of a superconducting niobium cavity according to claim 1, wherein the base plate is of a circular structure with an interstitial hole at a center, a plurality of first positioning pin holes are distributed around the interstitial hole, and the plurality of first positioning pin holes one-to-one correspond to second positioning pin holes on a connecting ring disposed on an end portion of the clamping shaft, to allow fixing and connection of the base plate and the clamping shaft.

7. A method for electron beam welding of a cavity body and a beam tube of a superconducting niobium cavity by using the special tooling according to claim 1, comprising: welding a flange to one end of a beam tube, then performing preprocessing on the flange, the beam tube, and a stamped semi-cavity body, and then clamping the preprocessed flange and semi-cavity body by using the special tooling according to claim 1, and finally performing electron beam welding after the clamping, wherein the electron beam welding comprises following steps:
1) clamping and fixing a clamping shaft by using a three-jaw chuck for the electron beam welding, then rotating the semi-cavity body upwards by 45° from an initial horizontal position parallel to an X axis, correcting axial and radial runouts of a welded seam to level the superconducting niobium cavity while maintaining a position, and after the leveling, tightening a bolt on a first clamping device and placing the device in a vacuum chamber;
2) vacuumizing the vacuum chamber to less than 10 mbar to 5 mbar to enable the three-jaw chuck to drive the superconducting niobium cavity to rotate, and performing tack welding at a to-be-welded position on an inner side of the semi-cavity body by using an electron beam current of 2 mA to 5 mA, wherein the tack welding is performed on four points evenly distributed around the welded seam;
3) using an electron beam current of 15 mA to 20 mA in form of a circular wave, a sine wave, or an 8-shaped scanning wave to complete welding at the to-be-welded position on the inner side of the semi-cavity body at a scanning amplitude of 0.3 mm to 1 mm, then unvacuuming, removing a second clamping device that fixes the semi-cavity body, and re-vacuumizing the vacuum chamber to be less than 10 mbar to 5 mbar to enable the three jaw chuck to drive the superconducting niobium cavity to rotate to the initial horizontal position in the step 1); and
4) using an electron beam current of 35 mA to 45 mA in form of the circular wave, the sine wave, or the 8-shaped scanning wave to complete welding at a to-be-welded position on an outer side of the semi-cavity body at a scanning amplitude of 0.5 mm to 2 mm, to complete a welded connection between the semi-cavity body and the beam tube.

8. The method according to claim 7, wherein the preprocessing comprises: placing the flange and the beam tube which are welded with each other together with the stamped semi-cavity body into a pickling solution to perform pickling; and after the pickling, spraying ultrapure water, and drying in an ultra-clean room to complete the preprocessing, wherein the pickling solution is an acid solution of a mixture of hydrofluoric acid, nitric acid, and phosphoric acid in a mass ratio of 1:1:2.

9. The method according to claim 7, wherein the clamping the preprocessed flange and semi-cavity body by using the special tooling specifically comprises:
i) clamping the flange by using the first clamping device, comprising:
installing a pressing ring on a side of the flange facing the beam tube, installing a base plate on another side of the flange, and then fixing the clamping shaft and the base plate, wherein
all bolts and nuts used for installation and fixing are not fully tightened, to facilitate subsequent leveling;
ii) connecting a connecting component with the first clamping device, comprising:
assembling a first pressing plate and a support plate of each connecting unit of the connecting component, and then bolting the first pressing plate of each connecting unit to the base plate; and
iii) connecting a second clamping device to the connecting component and the semi-cavity body, comprising:
aligning joints of the semi-cavity body and the beam tube, then assembling a second pressing plate with a pressing block of the second clamping device to form a plurality of clamping arms, then assembling the second pressing plate on each of the plurality of clamping arms with a first pressing plate of one connecting unit, and adjusting a total length of the second pressing plate and the first pressing plate to make the pressing block press against an equatorial edge of the semi-cavity body, and then using a bolt to make a fixed connection, to complete the clamping operation.

10. The method according to claim 7, wherein in a step of welding on the inner side of the step 3) and a step of welding on an outer side of the step 4), an acceleration voltage is 40 kV to 70 kV, a speed of a welding line is 6 mm/s to 10 mm/s, and a scanning frequency of an electron beam is 40 Hz to 500 Hz.
